(19) United States
(12) Patent Application Publication
(10) Pub. No.: US 2024/0143665 A1
(43) Pub. Date: May 2, 2024

(54) CENTRALIZED DATA PRESENTATION SYSTEM AND METHOD

(71) Applicant: RAKUTEN MOBILE. INC., Tokyo (JP)

(72) Inventors: Dewa SISWANTO, Tokyo (JP); Murugavel NATARAJAN, Bengaluru (IN); Vidyasagar MISHRA, Indore (IN)

(73) Assignee: RAKUTEN MOBILE, INC., Tokyo (JP)

(21) Appl. No.: 17/770,866

(22) PCT Filed: Jan. 19, 2022
(86) PCT No.: PCT/US2022/012845

§ 371 Date: Jul. 27, 2023

(51) Int. Cl. G06F 16/904; G06F 21/31

(52) U.S. Cl. CPC G06F 16/904; G06F 21/31; G06F 2221/2141

(57) ABSTRACT

A method of providing access to a data presentation system communicably connected to an application platform deploying a plurality of applications, and a data platform storing data output from the plurality of applications, includes: receiving, by the data presentation system, a request from a user to access a data presentation based on data output by at least one of the plurality of applications; determining, by the data presentation system, whether the received request is permitted; and based on the received request being permitted, processing the received request, wherein the processing the received request includes: determining first data of one or more applications, from among the data stored in the data platform, for presenting in the data presentation according to the request; obtaining, by the data presentation system, the first data from the data platform; processing, by the data presentation system, the first data into second data for presenting in the data presentation; adding the second data to the data presentation; and providing the data presentation to the user in accordance with the request.

### BACKGROUND

Multiple applications may be hosted and deployed in a particular ecosystem, such as a cloud platform for an enterprise or business. Typically, each application in the platform has its own mechanism for presenting reports of data generated or processed by the application or to configure a reporting template or dashboard for viewing the data. That is, each application must have its own reporting, data visualization, and/or dashboarding engine in the related art. Incorporating such data presentation mechanisms into each application, however, creates an overhead in the application development phase and redundancies across the multiple applications.

Further, because data presentation and reporting mechanisms are siloed within each application, this can cause a misalignment on the platform as a whole. For example, when one user is using multiple applications on the platform or when one user of one application wants to share a report or data visualization with another user of another application in the platform, the outputs may substantially vary from one application to another as each application typically implements a different standard for data presentation. A user experience and overall platform usability deteriorates as a result.

### SUMMARY

According to embodiments, a method of providing access to a data presentation system communicably connected to an application platform deploying a plurality of applications and a data platform storing data output from the plurality of applications, includes: receiving, by the data presentation system, a request from a user to access a data presentation based on data output by at least one of the plurality of applications; determining, by the data presentation system, whether the received request is permitted; and based on the received request being permitted, processing the received request, wherein the processing the received request includes: determining first data of one or more applications, from among the data stored in the data platform, for presenting in the data presentation according to the request; obtaining, by the data presentation system, the first data from the data platform; processing, by the data presentation system, the first data into second data for presenting in the data presentation; adding the second data to the data presentation; and providing the data presentation to the user in accordance with the request.

The determining whether the received request is permitted may include authenticating the user and determining whether the user has a preset permission for the requested access according to at least one of: preset user access rights defining access rights for the data presentation system on a per-user basis; preset group access rights defining access rights for the data presentation system on a per-group of user basis; preset data presentation access rights defining access rights for the data presentation system on a per-data presentation basis; and preset application access rights defining access rights for the data presentation on a per-application basis.

The determining whether the user has the preset permission may include determining a preset role of the user from among a plurality of predetermined roles each corresponding to different access rights.

The data presentation system may be configured to permit any of generating, editing, and viewing of data presentations when the request is a direct request from a user terminal that directly accesses the data presentation system via a graphical user interface of the data presentation system, and to not permit generating and editing of data presentations when the request is an indirect request via an application from among the plurality of applications.

The processing the first data into the second data may include standardizing a format of the first data into a standard format for the data presentation system.

The first data may include data output by a first application and having a first format, among the plurality of applications, and data output by a second application, among the plurality of applications, and having a second format different from the first format.

The processing the first data into the second data may include at least one of aggregating the first data, performing calculations on the first data, and generating visualization items based on the first data.

The method may further include: based on the received request being permitted and being a request to generate or to edit the data presentation, configuring the data presentation according to user inputs, wherein the configuring the data presentation may include receiving, from a user terminal, the user inputs to a graphical user interface of the data presentation system, the user inputs including at least one of: a first user input to select the first data from among the data stored in the data platform, a second user input to select one or more applications, from among the plurality of applications, as sources of the first data, and a third user input to select measures and/or dimensions corresponding to the second data for visualization in the data presentation.

The method may further include, based on the received request being permitted and being a request to view the data presentation, obtaining the data presentation from a data presentation storage of the data presentation system.

According to embodiments, a centralized data presentation system for providing access to data presentations, includes: a communication interface; an application programming interface (API) gateway; a memory storing instructions; and at least one processor configured to execute the instructions to: receive, via the communication interface or an API managed by the API gateway, a request from a user to access a data presentation based on data output by at least one of a plurality of applications deployed by an application platform communicably connected to the centralized data presentation system via the API gateway, determine whether the received request is permitted, based on the received request being permitted, processing the received request by: determining first data of one or more applications, from among data output by the plurality of applications and stored in a data platform communicably connected to the centralized data presentation system, for presenting in the data presentation according to the request, obtaining, by the data presentation system, the first data from the data platform, processing, by the data presentation system, the first data into second data for presenting in the data presentation, adding the second data to the data presentation, and providing the data presentation to the user in accordance with the request.

The at least one processor may be further configured to execute the instructions to determine whether the received request is permitted by authenticating the user and determining whether the user has a preset permission for the requested access according to at least one of: preset user access rights defining access rights for the data presentation system on a per-user basis; preset group access rights defining access rights for the data presentation system on a per-group of user basis; preset data presentation access rights defining access rights for the data presentation system on a per-data presentation basis; and preset application access rights defining access rights for the data presentation on a per-application basis.

The at least one processor may be further configured to execute the instructions to determine whether the user has the preset permission by determining a preset role of the user from among a plurality of predetermined roles each corresponding to different access rights.

The centralized data presentation system may be configured to permit any of generating, editing, and viewing of data presentations when the request is a direct request from a user terminal that directly accesses the data presentation system via a graphical user interface of the data presentation system, and to not permit generating and editing of data presentations when the request is an indirect request via an application from among the plurality of applications.

The at least one processor may be further configured to execute the instructions to process the first data into the second data by standardizing a format of the first data into a standard format for the centralized data presentation system.

The first data may include data output by a first application and having a first format, among the plurality of applications, and data output by a second application, among the plurality of applications, and having a second format different from the first format.

The at least one processor may be further configured to execute the instructions to process the first data into the second data by at least one of aggregating the first data, performing calculations on the first data, and generating visualization items based on the first data.

The at least one processor may be further configured to execute the instructions to, based on the received request being permitted and being a request to generate or to edit the data presentation, configure the data presentation according to user inputs, by receiving, from a user terminal, the user inputs to a graphical user interface of the data presentation system, the user inputs including at least one of: a first user input to select the first data from among the data stored in the data platform, a second user input to select one or more applications, from among the plurality of applications, as sources of the first data, and a third user input to select measures and/or dimensions corresponding to the second data for visualization in the data presentation.

The centralized data presentation system may further include a data presentation storage configured to store data presentations, wherein the at least one processor may be further configured to, based on the received request being permitted and being a request to view the data presentation, obtain the data presentation from the data presentation storage.

According to embodiments, a non-transitory computer-readable recording medium has recorded thereon instructions executable by at least one processor to perform a method of providing access to a data presentation system communicably connected to an application platform deploying a plurality of applications, and a data platform storing data output from the plurality of applications, the method including: receiving, by the data presentation system, a request from a user to access a data presentation based on data output by at least one of the plurality of applications; determining, by the data presentation system, whether the received request is permitted; and based on the received request being permitted, processing the received request, wherein the processing the received request includes: determining first data of one or more applications, from among the data stored in the data platform, for presenting in the data presentation according to the request, obtaining, by the data presentation system, the first data from the data platform, processing, by the data presentation system, the first data into second data for presenting in the data presentation, adding the second data to the data presentation, and providing the data presentation to the user in accordance with the request.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of a system architecture according to one or more embodiments;

FIG. 2 is a block diagram of a centralized data presentation system according to an embodiment;

FIG. 3 is a flowchart illustrating a method of accessing a centralized data presentation system according to an embodiment;

FIG. 4 is a flowchart illustrating a method of determining whether a request to access a data presentation system by a user is viable according to an embodiment;

FIG. 5 is a flowchart illustrating a method of determining whether a request to access a data presentation system by a user is viable according to another embodiment;

FIG. 6 is a flowchart illustrating a method of generating a data presentation according to an embodiment;

FIG. 7 is a flowchart illustrating a method of editing a data presentation according to an embodiment;

FIG. 8 is a flowchart illustrating a method of updating a data presentation according to an embodiment;

FIG. 9 is a flowchart illustrating a method of processing a request to access the data presentation system according to an embodiment;

FIGS. 10A to 10G are screens of a graphical user interface for generating a data presentation according to one or more embodiments; and

FIG. 11 is a diagram of components of one or more devices according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a centralized data visualization and reporting system communicatively coupled to multiple applications (e.g., within a cloud platform or across multiple platforms), wherein each of the users of the applications can access the centralized system to view data visualization, data dashboards, and/or data reporting. In at least one embodiment, the centralized system allows a user to configure the data visualization, data dashboard, and/or data reporting.

According to one or more example embodiments, data reporting and dashboarding capabilities are abstracted from each application in an ecosystem or platform and centralized in the data visualization and reporting system. As a result, developers of the applications need not create a reporting and dashboarding capability for each application or an individual data handling flow for each reporting and dashboarding use case. Instead, each application exposes its output or presentation data to a storage of (or accessible by) the centralized system (e.g., a data lake). Furthermore, the centralized data presentation system may include a dataset engine to build or generate a data cube or dataset from the exposed data to be processed for data visualization, reporting, or dashboarding (hereinafter “data presentation”). Thus, data presentation is standardized across all applications connected to the centralized data presentation system, with a standard process or workflow, thereby enhancing a user experience and platform usability and simplifying application development.

The centralized data visualization and reporting system (hereinafter “centralized data presentation system”) according to one or more example embodiments may provide at least one interface through which a user can create or configure data visualizations, report templates, and/or data dashboards (hereinafter “data presentations”) from the data exposed by the applications in the ecosystem (e.g., cloud platform). Specifically, the centralized data presentation system according to one or more example embodiments may include or provide at least one of a user interface for direct system access (e.g., a graphical user interface) and an interface (e.g., an Application Programming Interface (API)) for indirect system access through an application in the ecosystem or platform, through which the data presentations can be viewed, created, and/or modified. Accordingly, end users need not bother network or system administrators or engineers to request or report template changes or data visualization/dashboard changes, as any such changes can be performed easily and in a standard manner via the one or more interfaces. A user experience is therefore enhanced as a result of the increased flexibility afforded to end users to customize data presentations per each user's desires or needs. This built-in flexibility provided by the centralized system also reduces expenses and inconveniences for software or application enhancements that would otherwise be needed to accommodate each user's desires or needs.

According to one or more embodiments, each interface may provide different capabilities according to the type of interface (i.e., direct via user interface versus indirect via API). For example, data presentations may be viewed, created, and/or modified by a user who accesses the centralized data presentation system directly via the user interface based on the user's access right, while data presentations may only be viewed by a user who accesses the system via another application through the API.

Additionally or alternatively, the centralized data presentation system according to one or more example embodiments may also include authentication logic or functionality that restricts access to or permissions for the data presentations on a per-user basis. Different capabilities may be provided according to access rights of each user (or predefined access rights for predetermined roles assigned to each user). For example, a user who is assigned or has a first role (e.g., administrator) may have permissions to view, create, and modify the data presentations, a user who is assigned or has a second role (e.g., editor) may have permissions to only view and modify the data presentations, and a user who is assigned or has a third role (e.g., viewer) may have permission to only view data presentations. Because access to data in the system is based on authentication policies (through at least one of user-based access control and interface-based access control), data leaks and unauthorized access are minimized in accordance with one or more example embodiments.

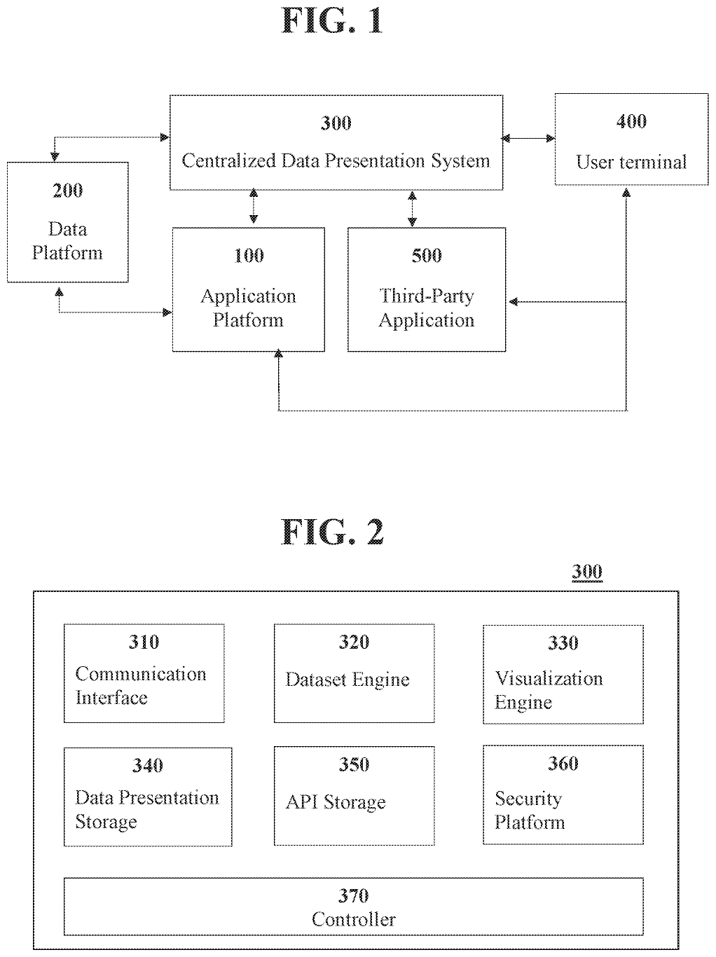

FIG. 1 is a diagram of a system architecture according to one or more embodiments. Referring to FIG. 1, the system architecture includes an application platform 100, a data platform 200, a centralized data presentation system 300 according to an embodiment, a user terminal 400, and a third-party application 500.

The application platform 100 is a platform that hosts and/or deploys one or more applications. The application platform 100 may be a cloud platform including one or more servers in which the one or more applications are deployed. For example, the application platform 100 may be a cloud platform for a particular business or enterprise in which applications are deployed for use by employees and/or customers of the business (e.g., applications for day-to-day operations of the business, processing or inputting sales information, communicating with customers, troubleshooting, etc.). The applications in the application platform 100 are configured to output or expose data that may be used for analysis and/or presentation (e.g., visualization, dashboarding, etc.).

The data platform 200 is communicatively connected or coupled to the application platform 100 and receives the data output by the one or more applications. The data platform 200 is a storage repository (e.g., one or more servers, data lake, data warehouse, etc.) that stores the data received from the application platform 100. By way of example, the data platform 200 may be a data lake that receives and stores data output from the application platform 100 in its native form. Further, the data platform 200 may store datasets corresponding to the applications in the application platform 100.

The centralized data presentation system 300 is communicatively connected or coupled to the data platform 200, and is configured to create, edit, and output data presentations from the data stored in the data platform 200. The centralized data presentation system 300 may also be communicatively connected or coupled to the application platform 100, and configured to output data presentations to one or more applications in the application platform 100. The centralized data presentation system 300 includes one or more computing devices (e.g., servers) having memory for storing executable instructions and at least one processor for executing those instructions to perform the functions (described in further detail below) of the centralized data presentation system 300.

The user terminal 400 is a user device through which a user accesses the centralized data presentation system 300 directly or indirectly via an application, namely, an application in the application platform 100 or the third-party application 500. Through the user terminal 400, an end user may generate, configure, and/or view a data presentation of the data presentation system, as will be set forth in further detail below.

FIG. 2 is a block diagram of the centralized data presentation system 300 according to an embodiment. Referring to FIG. 2, the centralized data presentation system 300 includes a communication interface 310, a dataset engine 320, a visualization engine 330, a data presentation storage 340, an API storage 350, a security platform 360, and a controller 370. In some embodiments, the data presentation storage 340, the API storage 350, and/or the security platform 360 are external to the centralized data presentation system 300.

The communication interface 310 is configured to communicatively connect or couple to the data platform 200, the application platform 100, and one or more user terminals 400 via a wired and/or wireless connection. The communication interface 310 may also connect to one or more third-party applications 500 in some embodiments. For example, the communication interface 310 may be directly connected to the data platform 200, the application platform 100, and/or the one or more user terminals 400 via a cable (e.g., universal serial bus (USB), coaxial, etc.). By way of another example, the communication interface 310 may be connected to the data platform 200, the application platform 100, and/or the one or more user terminals 400 via at least one network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, etc.), a public land mobile network (PLMN), a telephone network (e.g., the Public Switched Telephone Network (PSTN)), or the like, and/or a combination of these or other types of networks. The communication interface 310 may include at least one of an Ethernet interface, an optical interface, a coaxial interface, an infrared interface, a radio frequency (RF) interface, a USB interface, a Wi-Fi interface, a cellular network interface, or the like.

The dataset engine 320 is configured to receive (e.g., request or retrieve) one or more datasets from the data platform 200, via the communication interface 310, and process the data in accordance with a user request. For example, the dataset engine 320 may process the user request and perform an associated action based thereon, such as access a requested dataset from the data platform 200, standardize a form or format of the dataset, and provide the dataset to the visualization engine 330. For example, the data (or datasets) obtained from different applications may be of different formats. Accordingly, the dataset engine 320 converts a format(s) of the datasets into a standardized format for the data presentation system.

According to an embodiment, the dataset engine 320 may process raw or native data provided by the applications in the application platform 100 to generate datasets or data cubes having a standardized format, and store the datasets or data cubes in the data platform 200. According to another embodiment, a distinct dataset engine (e.g., included in the application platform 100 or the data platform 200) may process native data output by the applications into a standardized format for retrieval and processing by the dataset engine 320 in accordance with a user request.

The visualization engine 330 is configured to create, modify, refresh, and/or publish a data presentation (e.g., data visualization, report, and/or dashboard) in accordance with a user request. For example, the visualization engine 330 may generate or modify the fields or components of a data presentation (e.g., dashboard, report template, etc.) in accordance with a user request. Further, the visualization engine 330 may obtain, from the dataset engine 320, datasets required to populate the data presentation in response to a user request or based on a predefined (e.g., default or user set) refresh period for a previously generated data presentation.

The data presentation storage 340 is configured to store data presentations and/or templates generated or provided by the visualization engine 330. The data presentation storage 340 may include any device capable of storing data, such as a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. The data presentation storage 340 may be implemented as a plurality of storage devices. Further, the data presentation storage 340 may store metadata, attributes, or information regarding each data presentation. For example, the metadata, attributes or information may include at least one of a creator (user information) of the data presentation, one or more applications (or modules) that are source of a dataset presented or used by the data presentation, a date and/or time of creation of the data presentation, and a name of the data presentation. The metadata, attributes, or information may be stored together with the data presentation (e.g., within the same file) or separately from the data presentation.

The API storage 350 is configured to store a plurality of APIs for accessing features of the centralized data presentation system 300. In one or more embodiments, the APIs contain or manage a list of features provided by the centralized data presentation system 300 (e.g., viewing report A, configuring dashboard B, etc.), and information of users associated with the features (e.g., ID of users who have access to such features, etc.). The APIs may be created by the centralized data presentation system 300 or provided by one or more external sources. The API storage 350 may include any device capable of storing data, such as a hard disk (e.g., a magnetic disk, an optical disk, a magneto-optic disk, and/or a solid state disk), a CD, a DVD, a floppy disk, a cartridge, a magnetic tape, and/or another type of non-transitory computer-readable medium, along with a corresponding drive. The API storage 350 may be implemented as a plurality of storage devices. The data presentation storage 340 and the API storage 350 may be physically distinct storages or may be logically distinct storages within a same storage device. According to an embodiment, the API storage 350 may be or include an API gateway.

The security platform 360 is configured to authenticate users accessing the data presentation system 300, and to manage access rights of users and/or applications to the data presentation system 300. The security platform 360 may store and/or manage at least one of user authentication information, application access rights, user access rights, group access rights, and data presentation access rights.

The user authentication information may include user identifiers or log-in names and corresponding password information. Accordingly, the security platform 360 may authenticate any user who access the data presentation system 300, either directly or indirectly via an application (e.g., an application in the application platform 100 or a third-party application 500 external from the application platform 100).

The application access rights may define or mange, for each application, the data presentations (if any) that the application has access rights to and/or any restrictions to the access (e.g., view-only). According to an embodiment, access to data presentations via an application may be restricted to view-only rights (although it is understood that one or more other embodiments are not limited thereto, and access rights for each application may be variably defined in the application access rights). The application access rights may be managed in a rights management table or store associating each application with corresponding rights (e.g., for each application, at least one of corresponding data presentations that that application has access to, corresponding rights or permissions for the application, etc.).

The user access rights may define or manage, for each user, the access rights of the user. For example, the user access rights may store or manage, for each user, a user role from among a plurality of predetermined roles (e.g., Administrator, Editor, Viewer). Alternatively (or additionally), the user access rights may store or manage, for each user, the access rights that the user has on a data presentation-by-data presentation basis (e.g., user A has access rights to data presentation A and data presentation B, user B has access rights to data presentation B and data presentation C, etc.). In this case, the user access rights may define the specific access rights that the user has on a data presentation-by-data presentation basis (e.g., user A has view-only or Viewer rights to data presentation A and editing and viewing or Editor rights to data presentation B, user B has all or Administrator rights to data presentation B and view-only or Viewer rights to data presentation C, etc.). The user access rights may be managed in a rights management table or store associating each user with corresponding rights (e.g., for each user, at least one of a corresponding user role, corresponding data presentations that that user has access to, corresponding rights or permissions for the user to one or more data presentations, etc.).

The group access rights may define or manage, for each of predefined or predetermined groups of users (e.g., manually-created or defined group, company department, etc.), the access rights of the group. For example, the group access rights may store or manage, for each group, a role from among a plurality of predetermined roles (e.g., Administrator, Editor, Viewer). Alternatively (or additionally), the group access rights may store or manage, for each group, the access rights that the group has on a data presentation-by-data presentation basis (e.g., group A has access rights to data presentation A and data presentation B, group B has access rights to data presentation B and data presentation C, etc.). In this case, the group access rights may define the specific access rights that the group has on a data presentation-by-data presentation basis (e.g., group A has view-only or Viewer rights to data presentation A and editing and viewing or Editor rights to data presentation B, group B has all or Administrator rights to data presentation B and view-only or Viewer rights to data presentation C, etc.). The group access rights may be managed in a rights management table or store associating each group with corresponding rights (e.g., for each group, at least one of a corresponding role, corresponding data presentations that that group has access to, corresponding rights or permissions for the group to one or more data presentations, etc.). The group access rights management table can be separate from or incorporated with the user access rights management table described above.

The data presentation access rights may define or manage, for each data presentation, access rights for that presentation. For example, the data presentation access rights may store or manage, for each data presentation, users, groups, and/or applications that have rights to access that presentation (e.g., group A, user A, and application B has access rights to data presentation A, group A and application has access rights to data presentation B, etc.). Further, the data presentation access rights may store or manage, for each data presentation, the specific access rights that each user, group, and/or application has to that presentation (e.g., group A has viewing and editing rights, user A has all rights, and application B has view-only rights to data presentation A, etc.). Alternatively (or additionally), the data presentation access rights may store or manage, for each data presentation, the data sources (i.e., application sources) for the data used in that data presentation. Accordingly, access to the data presentations may be controlled based on the relevant applications (e.g., indirect access via an application can be restricted to only those data presentations that are based on data from the application). The data presentation access rights may be managed in a rights management table or store associating each data presentation with corresponding rights (e.g., for each data presentation, at least one of users, groups, and applications that have access rights, corresponding rights or permissions thereof, etc.).

By incorporating a security platform 360, every access (both direct and indirect) to the centralized data presentation system 300 and the data presentations stored therein can be managed to prevent unauthorized access and data leaks.

The controller 370 is configured to control overall operations of the centralized data presentation system 300 and the components thereof. The controller 370 may include at last one processor (e.g., a central processing unit (CPU), a system-on-chip (SoC), an accelerated processing unit (APU), a microprocessor, a microcontroller, a digital signal processor (DSP), a field-programmable gate array (FPGA), an application-specific integrated circuit (ASIC), a backend processing engine, or another type of processing component). In some implementations, the controller 370 includes one or more processors capable of being programmed to perform a function. The controller 370 may also include at least one memory, such as a random-access memory (RAM), a read only memory (ROM), and/or another type of dynamic or static storage device (e.g., a flash memory, a magnetic memory, and/or an optical memory) that stores information and/or instructions for use by the at least one processor.

### Direct User Access

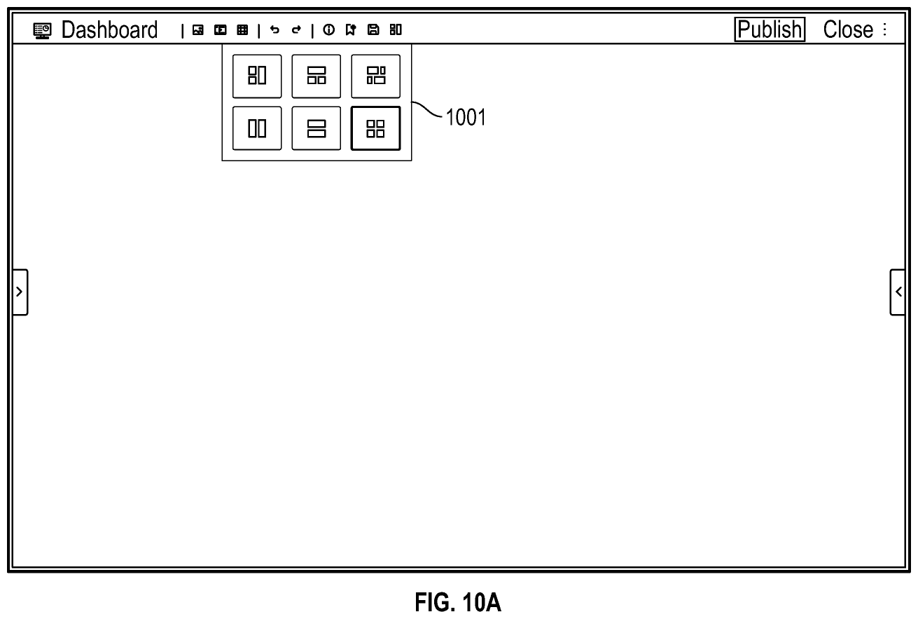

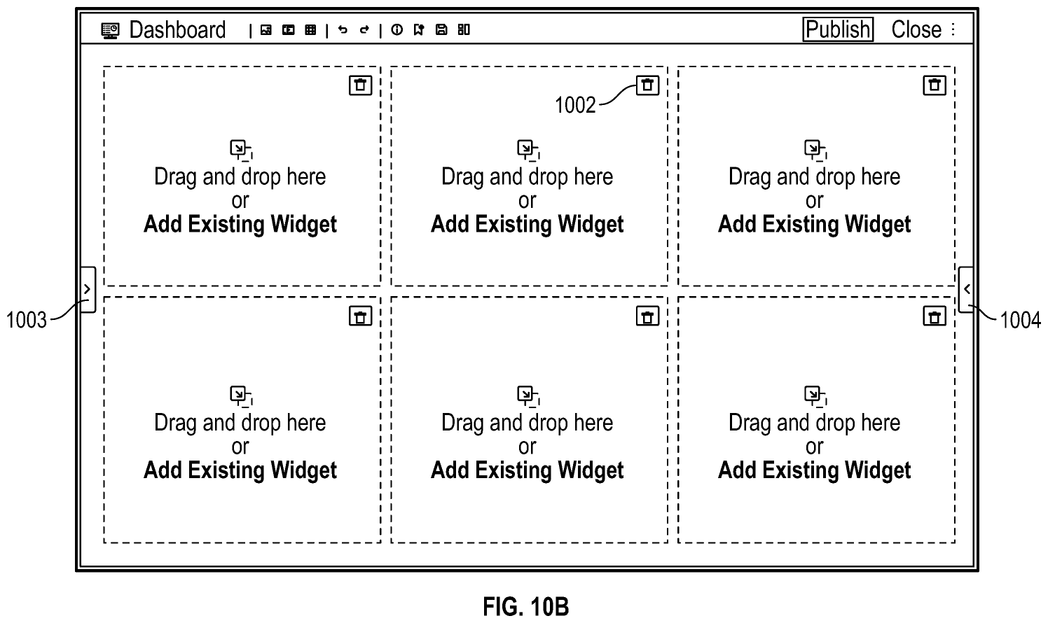

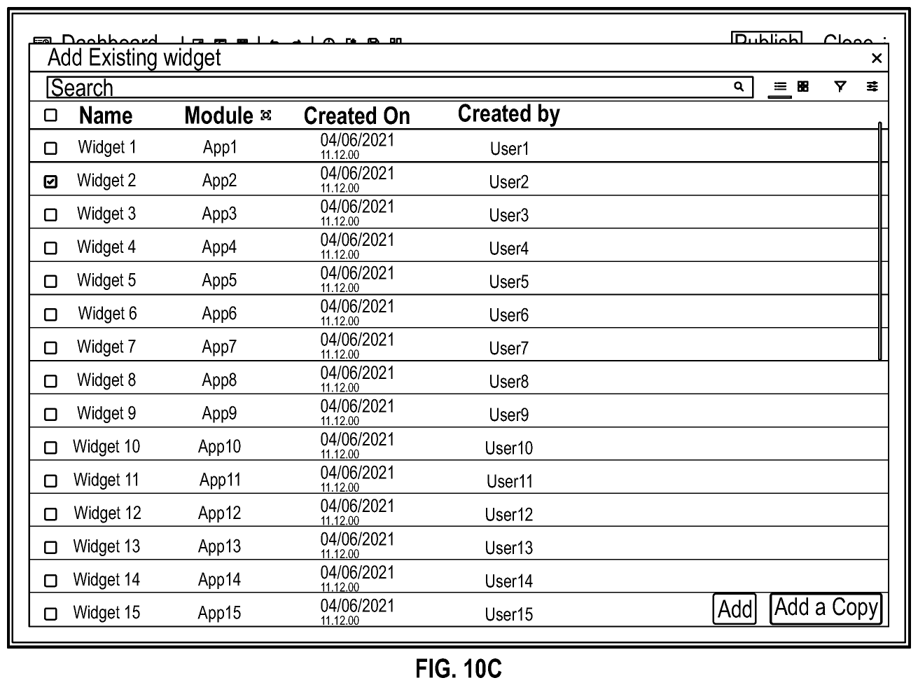

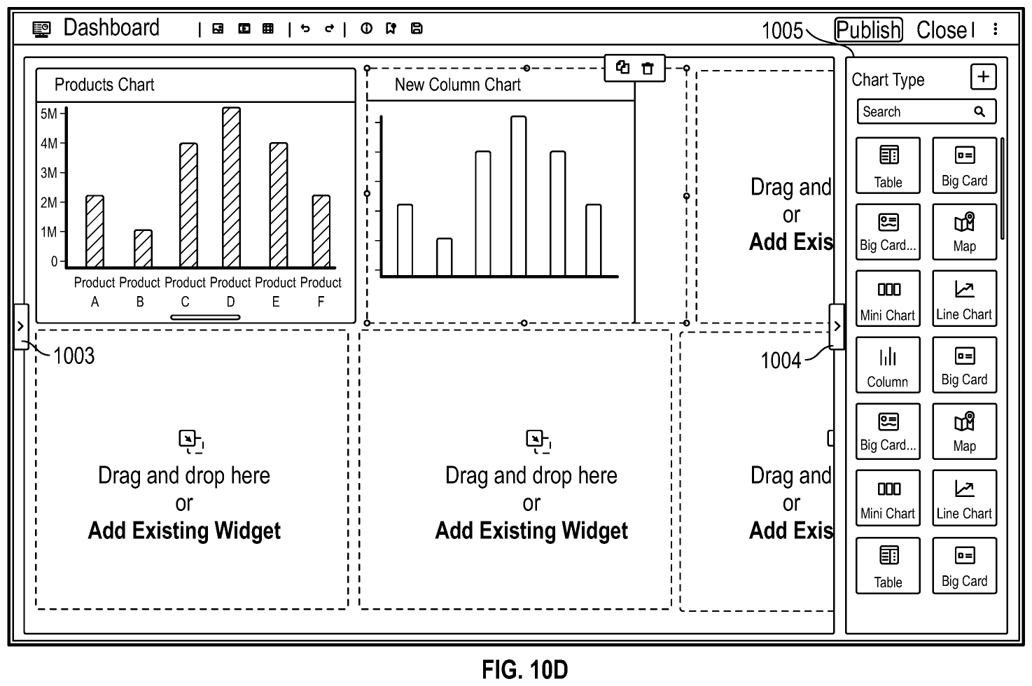

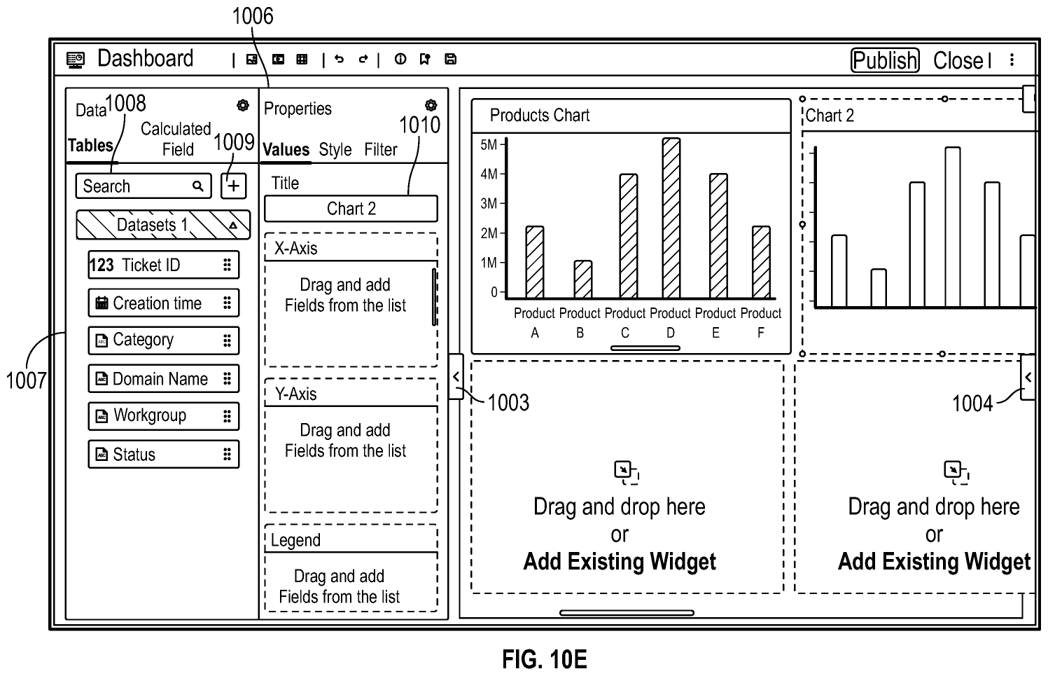

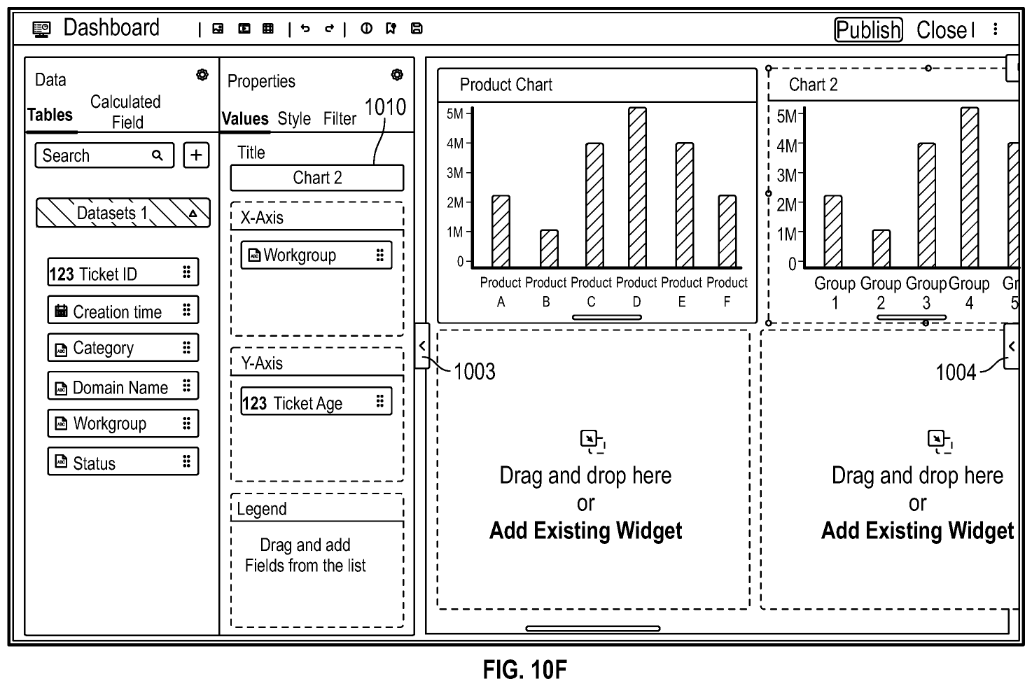

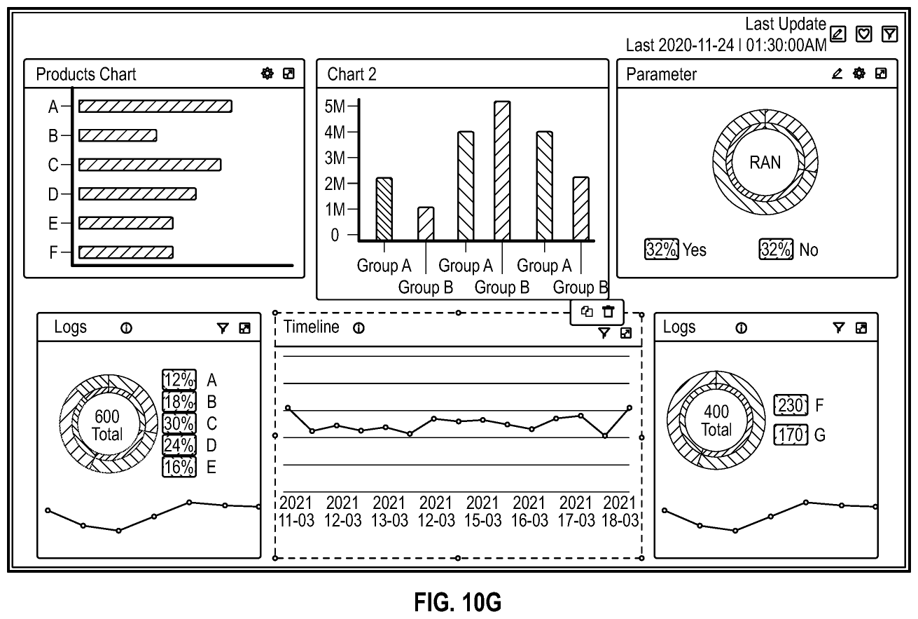

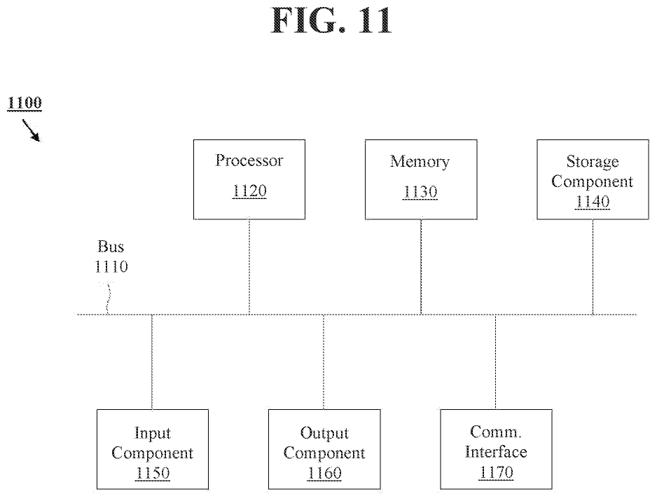

The controller 370 may be configured to generate a graphical user interface and to provide the graphical user interface to a user terminal 400 via the communication interface 310, in order to allow for direct access to the centralized data presentation system 300 (as opposed to access via a third-party application 500 or an application in the application platform 100). The graphical user interface (e.g., a webpage or markup language file) may be stored in a storage (which may be included in or external from the centralized data presentation system 300). According to another embodiment, the graphical user interface may be stored in an external server. The graphical user interface may be accessed by the user terminal 400 via a location identifier or address (e.g., uniform resource indicator (URI), a uniform resource locator (URL), a file path, etc.). The graphical user interface allows an end user to perform an action with the centralized data presentation system 300 (such as generate a data presentation, view a certain data presentation, configure the data illustration or reporting format in a data presentation, etc.) via certain functional elements presented on the graphical user interface, such as buttons, scroll bars, etc. Further, the graphical user interface may allow a user (or a particular type of user, such as an Administrator or the creator of a data presentation) to set or edit the access rights for a data presentation (e.g., user access rights, application access rights, group access rights, data presentation access rights, etc.). A graphical user interface for generating a data presentation according to an embodiment is described in further detail below with reference to FIGS. 10A to 10G.

According to an embodiment, direct access via the user interface to a particular data presentation may be restricted based on user. For example, the controller 370 may forward the user's request and/or user information (e.g., identification information, a password, etc.) to the security platform 360 for authenticating the user, and receive an authorization based on the authentication. Further, a user's authorization may be limited based on predefined access rights for the user. For example, the user may only have viewing rights, may only have viewing and edit rights, or may have viewing, editing, and creating rights. Access rights may be applied to a user based on predefined roles. For example, a user that is assigned or has a predetermined first role (e.g., Administrator) will have full access to all possible features, a user that is assigned or has a predetermined second role (e.g., Editor) will have full access to read and view the data presentations and at least some rights to features for editing the data presentation, and a user that is assigned or has a third role (e.g., Viewer) will only have access to read and view the data presentation but will not be able to edit the data presentation.

### Indirect User Access

The controller 370 may control to provide indirect user access to the centralized data presentation system 300 via a user interface of another application, e.g., one or more of the applications deployed by the application platform 100 or a third-party application 500. According to an embodiment, an end user may request, via a user interface of an application in the application platform 100 or the third-party application 500, access to the data presentation system 300. In this case, the user's request is forwarded to the controller 370 or to the API storage 350 (e.g., API gateway) via an API for handling, e.g., to determine whether the request is viable based on the APIs stored in the API storage 350. For example, the controller 370 (or an API gateway) may determine whether the user has the right to use the centralized system, whether the requested access is permitted via the application, what is the role available to the user, etc.

According to an embodiment, indirect access via an application to a particular data presentation may be restricted to only those data presentations for which the application has access rights. In various embodiments, an application's permission to access a particular data presentation may be set by an administrator, may be set by the creator of the data presentation, and/or may be based on the application's relation to that data presentation. For example, in an embodiment, an application may have access rights to only those data presentations that are generated based on data output or provided by that application.

According to an embodiment, indirect access via an application to a particular data presentation may be restricted to a particular type of use. For example, a user may only be able to view a data presentation via an application in the application platform 100, and may not be permitted to edit or create a data presentation via the application, irrespective of the user's general access rights or role (e.g., irrespective of whether the user is an Administrator, the user will only be permitted to view the data presentation if he indirectly accesses the centralized data presentation system 300 via an application, etc.). In some embodiment, the types of use that are permitted may be limited or defined by the corresponding API, the application itself (and its user interface), etc.

According to an embodiment, indirect access via an application to a particular data presentation may be restricted based on user. For example, the controller 370 (or API gateway) may forward the user's request and/or user information (e.g., identification information, a password, etc.) to the security platform 360 for authenticating the user, and receive an authorization based on the authentication. Further, a user's authorization may be limited based on predefined access rights for the user. For example, the user may only have viewing rights, may only have viewing and edit rights, or may have viewing, editing, and creating rights. Access rights may be applied to a user based on predefined roles. For example, a user that is assigned or has a predetermined first role (e.g., Administrator) will have full access to all possible features, a user that is assigned or has a predetermined second role (e.g., Editor) will have full access to read and view the data presentations and at least some rights to features for editing the data presentation, and a user that is assigned or has a third role (e.g., Viewer) will only have access to read and view the content but will not be able to edit the content.

If the user's request is not viable or permitted, the controller 370 (or API gateway) may be configured to generate an error message and to send the error message, or otherwise inform the application or user, that access is not permitted.

If the user's request is permitted, the controller 370 provides the requested data presentation or processes the requested data presentation in accordance with the user's request to the application via a corresponding API.

### Generating Data Presentation

According to one or more embodiments, the controller 370 (e.g., at least one processor executing instructions) controls operations of at least one of the communication interface 310, the dataset engine 320, the visualization engine 330, the data presentation storage 340, and the API storage 350 to generate a data presentation in accordance with a user request.

For example, the controller 370 may receive, from a user terminal 400 via the communication interface 310, a user request to generate a data presentation. The request may be received via the graphical user interface displayed or output by the user terminal 400. As described above, the graphical user interface may be provided by the centralized data presentation system 300 via the communication interface 310 or may be stored in an external device or server. Alternatively, the graphical user interface may be provided by another application in some embodiments (e.g., a third-party application 500 or an application in the application platform 100).

In accordance with an embodiment, the graphical user interface allows an end user to define and/or configure a desired data presentation (e.g., generated report, report template, data visualization, and/or dashboard) for presenting data (e.g., data associated with an application of application platform 100, data associated with a third-party application 500, data associated with the centralized data presentation system 300, data associated with the user, etc.) stored in the data platform 200. For example, through the graphical user interface, the end user is able to configure the data presentation by selecting data fields as well as types and/or roles for each field to be used (e.g., types of measures or data calculated or aggregated from data available in the data platform 200, dimensions or qualitative data, etc.), an arrangement of the fields, graphical representations of the fields (e.g., graphs, charts, etc.), display positions of one or more components of the data presentation, etc. The fields and/or their definitions may be selected from among a plurality of predetermined or previously-generated fields, measures, dimensions, etc., or may be newly-defined by the end user. The graphical user interface allows the end user to select data fields based on data from a plurality of different applications (and of a plurality of different native formats), for inclusion, processing, and/or presentation/visualization in the same data presentation. Further, through the graphical user interface, the end user may define an aggregation for every measure, may select a report output type (e.g., CSV, PDF, etc.), may define filter parameters based on available data, may set an auto refresh period for refreshing the data presentation, and/or may manage user access by specifying authenticated users or authenticated user roles or permissions, application rights, group rights, etc. In some embodiments, through the graphical user interface, the end user may select a previously generated data presentation stored in the data presentation storage 340, and modify the previously generated presentation to create a new data presentation. Further, in one or more embodiments, a user may select for inclusion in a data presentation one or more graphical representations (e.g., widgets or tiles in which a graph, chart, etc., is presented) from among previously generated graphical representations (e.g., previously generated for another data presentation), or from among stored predefined templates for graphical representations.

The controller 370 is configured to receive the user selections made via the graphical user interface, and control the visualization engine 330 to generate the data presentation accordingly. Further, the controller 370 may be configured to store the generated data presentation in the data presentation storage 340.

The controller 370 is configured to populate or publish the data presentation with data stored in the data platform 200. For example, in response to a user's request (e.g., via the graphical user interface) to add data to or generate a data presentation, view a data presentation, and/or refresh a data presentation, the controller 370 controls the dataset engine 320 to determine the data needed for the data presentation, access one or more corresponding datasets from the data platform 200, standardize the datasets, and provide the datasets to the visualization engine 330. According to another embodiment, the datasets may be standardized beforehand, e.g., upon or based on storage in the data platform 200. Further, the controller 370 is configured to control the visualization engine 330 to process the datasets (e.g., aggregate the data, perform calculations, generate visualization items or graphical representations (e.g., graphs, charts, etc.), consolidate the data, etc.) to obtain data for the data presentation, and update or populate the data presentation with the obtained data. Additionally, the controller 370 is configured to control the visualization engine 330 to modify presentation parameters or styles (e.g., colors of bars or parts of a graph, pie chart, etc., an orientation of a chart or graph, X- and Y-axes of a graph, etc.).

The controller 370 may control to store the populated data presentation in the data presentation storage 340. For example, the controller 370 may control to store the populated data presentation and metadata indicative of a date and/or time that the data presentation is generated or populated with the data. The data presentation storage 340 may store a data presentation template in addition to a plurality of different versions of the same data presentation, corresponding to different dates and times in which the data presentation template is populated or updated with data. Further, the data presentation storage 340 (or an additional storage) may store sub-parts of the data presentation, e.g., graphical representations (such as tiles or widgets in which charts, graphs, etc., are included) that can be individually selected at a later time by a user for inclusion in another data presentation.

The controller 370 is configured to transmit or provide the generated data presentation to the user terminal 400 via the communication interface 310.

### Editing Data Presentation

According to one or more embodiments, the controller 370 (e.g., at least one processor executing instructions) controls operations of at least one of the communication interface 310, the dataset engine 320, the visualization engine 330, the data presentation storage 340, and the API storage 350 to modify or reconfigure a data presentation in accordance with a user request.

For example, the controller 370 may receive, from a user terminal 400 via the communication interface 310, a user request to edit an existing/generated data presentation. The request may be received via the graphical user interface displayed or output by the user terminal 400. As described above, the graphical user interface may be provided by the centralized data presentation system 300 via the communication interface 310 or may be stored in an external device or server. Alternatively, the graphical user interface may be provided by another application in some embodiments (e.g., a third-party application 500 or an application in the application platform 100).

In accordance with an embodiment, the graphical user interface allows an end user to edit or reconfigure a data presentation. For example, through the graphical user interface, the end user is able to select a data presentation stored in the data presentation storage 340. The controller 370 controls to read the selected data presentation from the data presentation storage 340 and provide the same to the user terminal 400 for display and editing. The graphical user interface displayed on the user terminal 400 allows the user to reconfigure the data presentation by adding or removing data fields as well as types and/or roles for each field (e.g., types of measures or data calculated or aggregated from data available in the data platform 200, dimensions or qualitative data, etc.) to be used, an arrangement of the fields, graphical representations of the fields (e.g., graphs, charts, etc.), display positions of one or more components of the data presentation, etc. The fields and/or their definitions may be selected from among a plurality of predetermined or previously-generated fields, measures, dimensions, etc., or may be newly-defined by the end user. Further, through the graphical user interface, the end user may define or modify an aggregation for every measure, may modify a report output type (e.g., CSV, PDF, etc.), may define or modify filter parameters based on available data, may set or modify an auto refresh period for refreshing the data presentation, and/or may manage user access by specifying authenticated users or authenticated user roles or permissions, application rights, group rights, etc. It is understood that one or more of the above features may be restricted based on the access rights of the user that is editing the data presentation.

In editing the data presentation, if the user requests an additional dataset or additional data to be added or considered in the data presentation, the controller 370 processes the request and requests a corresponding dataset from the dataset engine 320. The controller 370 controls to populate or refresh the edited data presentation in the same manner as described above with reference to generating a data presentation.

The controller 370 is configured to receive the user selections made via the graphical user interface, and control the visualization engine 330 to edit the data presentation accordingly (e.g., update the data visualization to include an additional data set, remove a dataset, etc.). Further, the controller 370 may be configured to store the edited data presentation in the data presentation storage 340, and to transmit or provide the edited data presentation to the user terminal 400 via the communication interface 310.

### Updating Data Presentation

According to one or more embodiments, the controller 370 (e.g., at least one processor executing instructions) controls operations of at least one of the communication interface 310, the dataset engine 320, the visualization engine 330, the data presentation storage 340, and the API storage 350 to update or refresh a data presentation in accordance with a user request or in accordance with a predefined refresh period (or predefined publication period, such as at the beginning of each work day or at fixed intervals throughout the day). For example, the controller 370 may control the dataset engine 320 to provide corresponding datasets and may control to populate the data presentations with the data in response to an event (e.g., a user request to view a data presentation stored in the data presentation storage 340, a user request to update or refresh a data presentation being viewed by the user, a detected or determined change to corresponding datasets in the data platform 200, a predefined publication period for a data presentation, etc.) and/or in accordance with a predefined automatic refresh period.

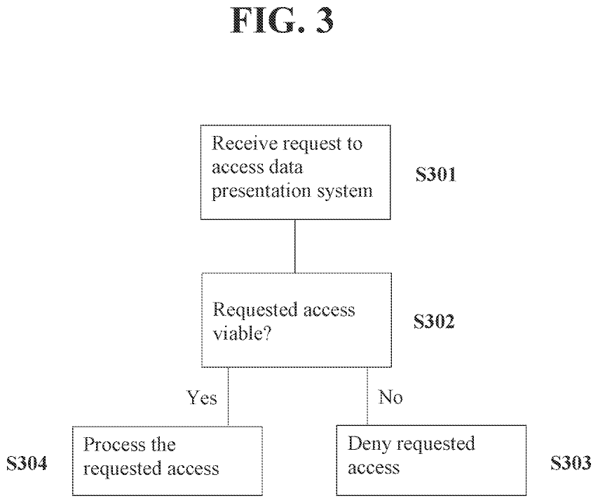

FIG. 3 is a flowchart illustrating a method of accessing the centralized data presentation system 300 according to an embodiment. Referring to FIG. 3, in operation S301, the data presentation system 300 receives a request from a user to access the centralized data presentation system. The request may be received directly (e.g., via a graphical user interface provided by or for the data presentation system 300) or indirectly (e.g., from an application in the application platform 100 or externally, and/or through the API gateway). In operation S301, the data presentation system 300 may receive a request to access (e.g., view or edit) a data presentation generated by the data presentation system 300 from data output by one or more applications in the application platform 100 and processed (e.g., standardized) by the dataset engine 320 to be aggregated or presented in the data presentation, said data presentation stored in the data presentation storage 340. Further, the data presentation system 300 may receive a request to generate a new data presentation from data output by one or more applications in the application platform 100 and then processed by the dataset engine 320.

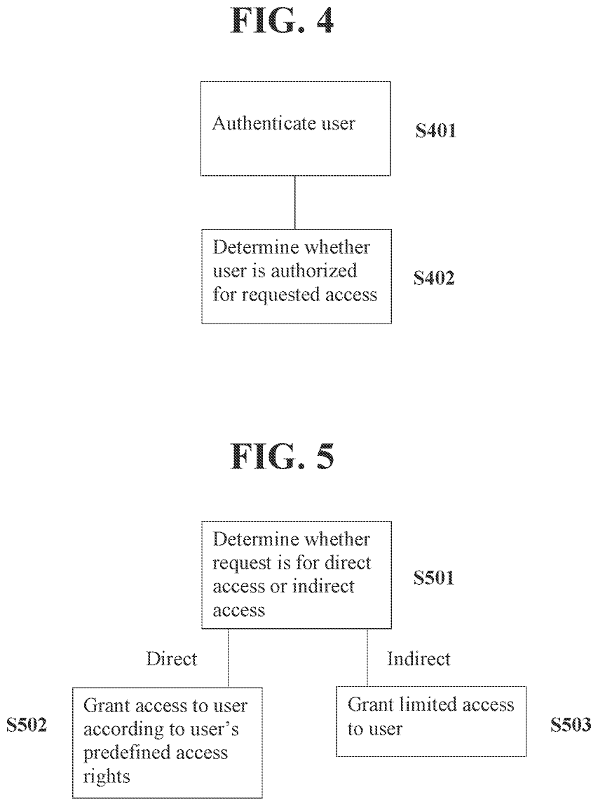

In operation S302, the data presentation system 300 determines whether the requested access is viable or permitted. A detailed description of operation S302 according to one or more embodiments is provided below with reference to FIGS. 4 and 5. If the requested access is determined to not be viable (“No” in operation S302), the data presentation system 300 denies the requested access in operation S303. For example, the data presentation system 300 may send an error message or otherwise notify the user that the request has been denied. If the requested access is determined to be viable (“Yes” in operation S302), the data presentation system processes the requested access (e.g., provides the requested access to the user) in operation S304.

FIG. 4 is a flowchart illustrating a method of determining whether a request to access a data presentation system 300 by a user is viable according to an embodiment. Referring to FIG. 4, in operation S401, the user is authenticated. For example, the user is authenticated by forwarding the request (e.g., from the API gateway or the communication interface 310) to the security platform 360, and the security platform 360 determines whether the user is authorized to access the data presentation system 300. In this case, the request may include authentication information (e.g., a user name and/or password). Alternatively, the authentication information is received prior to or separately from the request, and the user is authenticated separately from handling of the request.

In operation S402, the data presentation system 360 determines whether the user is authorized for the requested access. For example, the request is forwarded from the API gateway or the communication interface 310 to the security platform 360, and the security platform 360 may determine whether the user is authorized for the requested access (e.g., authorized to edit or create a data presentation), according to a user's predefined role or predefined access rights (e.g., at least one of user access rights, group access rights, data presentation access rights, and application access rights). The user's access may be based on at least one of: whether the access is direct (e.g., from a graphical user interface provided by or for the centralized data presentation system 300) or indirect (e.g., via an application in the application platform 100 or external), the type of access requested (viewing, editing, creating, etc.), the user's predefined role (e.g., Viewer, Editor, Administrator), the user's predefined access rights, a requested data presentation's predefined access rights, an application's predefined access rights, etc. Based on the determination of S402, the user request is either denied or approved.

FIG. 5 is a flowchart illustrating a method of determining whether a request to access a data presentation system 300 by a user is viable according to another embodiment. Referring to FIG. 5, in operation S501, the data presentation system 300 determines whether the request is for a direct access (e.g., via the graphical user interface described above) or an indirect access (e.g., via an application of the application platform 100 or an external application).

If the access is a direct access, the method proceeds to operation S502, in which the user is given access rights to the data presentation system 300 in accordance with the user's predefined access rights. Specifically, the request is forwarded to the security platform 360, and the user is authenticated. That is, the security platform 360 may determine whether the user is authorized to access the data presentation system 300. In this case, the request (or a prior log-in request received from the user) may include authentication information (e.g., a user name and/or password). Further, the security platform 360 determines whether the user is authorized for the requested access (e.g., authorized to edit or create a data presentation system), according to a user's predefined role or predefined access rights (e.g., at least one of user access rights, group access rights, and data presentation access rights).

If the access is an indirect access, the method proceeds to operation S503, in which the user is given limited access rights to the data presentation system 300. In the present embodiment, the user is given only viewing rights for data presentations stored in the data presentation system 300, based on the access being an indirect access. In some embodiments, the user is given only viewing rights and editing rights for data presentations, but will not be given rights to add new data presentations, based on the access being indirect. Additionally or alternatively, in operation S503, the indirect access request may be forwarded (e.g., by the API gateway) to the security platform 360 to authenticate the user and determine whether the user is authorized for the requested access according to a user's predefined role or predefined access rights (e.g., at least one of user access rights, group access rights, application access rights, and data presentation access rights). According to another embodiment, a request via an application is forwarded to the API gateway, which determines whether or not the user's request is viable (e.g., whether the user has the right to use the centralized system, etc.) or forwards the request to the security platform 360 to make such a determination. If it is determined that the user's request is not viable, an error message or other notification may be sent to the user via the API gateway. If it is determined that the user's request is viable, the request is forwarded to the security platform 360, which authenticates the user and sends an authorization to the API gateway.

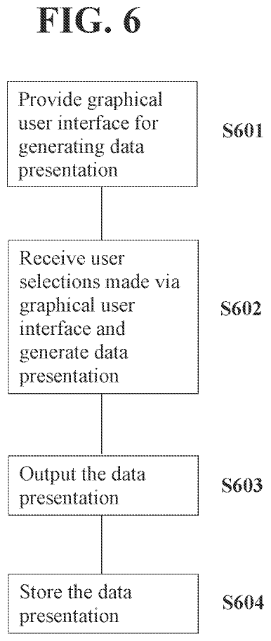

FIG. 6 is a flowchart illustrating a method of generating a data presentation according to an embodiment. Referring to FIG. 6, in operation S601, the data presentation system 300 controls to provide, to a user terminal 400, a graphical user interface for generating a data presentation. The data presentation system 300 may control to provide the graphical user interface, stored in a storage of the data presentation system, via the communication unit 310 or may control to provide the graphical user interface stored in an external storage (e.g., a cloud server, a web server, an application server, etc.). Further, the user terminal 400 may directly access the graphical user interface via location information (e.g., a web address, a URI, a URL, a file path, etc.). According to another embodiment, the graphical user interface may be provided in an application, such as an application included in the application platform 100 (although in other embodiments, a data presentation is restricted from being generated via another application) or a third-party application 500 external from the application platform 100. In that case, the user may indirectly access the data presentation system 300 via the application.

The graphical user interface includes at least one of drop down menus, drag-and-drop objects, finable fields, buttons, etc., to allow a user to define and/or configure a desired data presentation for presenting data stored in the data platform 200. For example, through the graphical user interface, the user is able to configure the data presentation by selecting data fields as well as types and/or roles for each field to be used (e.g., types of measures or data calculated or aggregated from data available in the data platform 200, dimensions or qualitative data, etc.), an arrangement of the fields, graphical representations of the fields (e.g., graphs, charts, etc.), display positions of one or more components of the data presentation, etc. The fields and/or their definitions may be selected from among a plurality of predetermined or previously-generated fields, measures, dimensions, etc., or may be newly-defined by the user. Further, through the graphical user interface, the user may define an aggregation for every measure, may select a report output type (e.g., CSV, PDF, etc.), may define filter parameters based on available data, may set an auto refresh period for refreshing the data presentation, and/or may manage user access by specifying authenticated users or authenticated user roles or permissions, application rights, group rights, etc. Additionally, through the graphical user interface, the user may select a previously generated data presentation stored in the data presentation storage 340, and modify the previously generated presentation to create a new data presentation.

In operation S602, the data presentation system 300 receives the user selections made via the graphical user interface, and generates (e.g., by the visualization engine) the data presentation accordingly. According to another embodiment, the data presentation is generated (at least in part) locally in the user terminal 400, and then provided to the data presentation system for populating and/or storing. Further, the data presentation system 300 controls to populate the data presentation from data stored in the data platform 200. For example, the controller 370 controls the dataset engine 320 to determine the data needed for the data presentation, access one or more corresponding datasets from the data platform 200, standardize the datasets, and provide the datasets to the visualization engine 330. Further, the controller 370 is configured to control the visualization engine 330 to process the datasets (e.g., aggregate the data, perform calculations, etc.) to obtain data for the data presentation, and populate the data presentation with the obtained data.

In operation S603, the data presentation system 300 controls to output the data presentation to the user terminal 400. In operation S604, the data presentation system 300 controls to save or store the data presentation in the data presentation storage 340. The data presentation may be stored in its current state (i.e., populated with the obtained data), and/or may be stored as a template (i.e., without the obtained data).

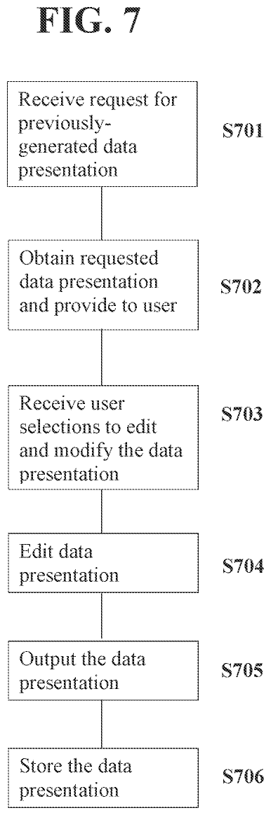

FIG. 7 is a flowchart illustrating a method of editing a data presentation according to an embodiment. Referring to FIG. 7, in operation S701, the data presentation system 300 receives a request for a previously-generated data presentation from a user terminal 400. The request may be received from the user terminal 400 via the direct access method, or through an application via an indirect access method.

In operation S702, the data presentation system 300 obtains the previously-generated data presentation (either as a template or populated with data) from the data presentation storage 340 and provides the same to the user terminal 400 (e.g., through the communication interface 310 and/or an API).

In operation S703, the data presentation system 300 receives a request or user selections to edit or modify the data presentation. The request may be input to a graphical user interface (similar to those described above) that allows the user to edit or reconfigure the data presentation. For example, through the graphical user interface, the user is able to select a data presentation stored in the data presentation storage 340. The controller 370 controls to read the selected data presentation from the data presentation storage 340 and provide the same to the user terminal 400 for display and editing. The graphical user interface displayed on the user terminal 400 allows the user to reconfigure the data presentation by adding or removing data fields as well as types and/or roles for each field (e.g., types of measures or data calculated or aggregated from data available in the data platform 200, dimensions or qualitative data, etc.) to be used, an arrangement of the fields, graphical representations of the fields (e.g., graphs, charts, etc.), display positions of one or more components of the data presentation, etc. The fields and/or their definitions may be selected from among a plurality of predetermined or previously-generated fields, measures, dimensions, etc., or may be newly-defined by the end user. Further, through the graphical user interface, the user may define or modify an aggregation for every measure, may modify a report output type (e.g., CSV, PDF, etc.), may define or modify filter parameters based on available data, may set or modify an auto refresh period for refreshing the data presentation, and/or may manage user access by specifying authenticated users or authenticated user roles or permissions, application rights, group rights, etc. It is understood that one or more of the above features may be restricted based on the access rights of the user that is editing the data presentation.

In operation S704, the data presentation system 300 (e.g., the visualization engine) edits or modifies the data presentation in accordance with the user requests or selections. In editing the data presentation, if the user requests an additional dataset or additional data to be added or considered in the data presentation, the controller 370 processes the request and requests a corresponding dataset from the dataset engine 320. The controller 370 controls to populate or refresh the edited data presentation in the same manner as described above with reference to generating a data presentation.

In operation S705, the data presentation system 300 controls to output the edited data presentation to the user terminal 400. In operation S706, the data presentation system 300 controls to save or store the data presentation in the data presentation storage 340. The data presentation may be stored in its current state (i.e., populated with the obtained data), and/or may be stored as a template (i.e., without the obtained data).

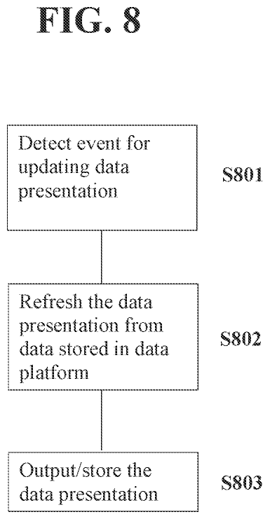

FIG. 8 is a flowchart illustrating a method of updating a data presentation according to an embodiment. Referring to FIG. 8, in operation S801, an event for updating the data presentation is determined or detected. For example, the event may be a user request to view a data presentation store din the data presentation storage 340, a user request to update or refresh a data presentation, a determined, detected, or signaled (e.g., by an application that outputs data presented in the data presentation) change to a corresponding dataset for the data presentation, or a predetermined time interval for a refresh of the data presentation.

In operation S802, the data presentation system 300 controls to refresh (or re-populate) the data presentation from data stored in the data platform 200. For example, the controller 370 controls the dataset engine 320 to determine the data needed for the data presentation (or determined the updated data for the data presentation), access one or more corresponding datasets from the data platform 200, standardize the datasets, and provide the datasets to the visualization engine 330. Further, the controller 370 is configured to control the visualization engine 330 to process the datasets (e.g., aggregate the data, perform calculations, etc.) to obtain data for the data presentation, and populate the data presentation with the obtained data.

In operation S803, the data presentation system 300 controls to output the updated data presentation to a user terminal 400, and/or to save or store the updated data presentation in the data presentation storage 340.

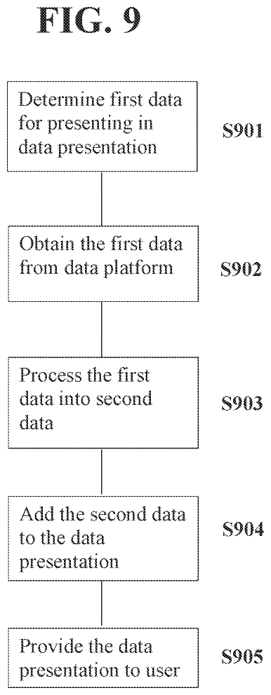

FIG. 9 is a flowchart illustrating a method of processing a request to access the data presentation system according to an embodiment. The method of FIG. 9 may correspond to operation S304 in FIG. 3.

Referring to FIG. 9, in operation S901, the controller 370 determines first data, of (or output from) one or more applications, needed for the data presentation according to the request. The first data is determined from among the data stored in the data platform 200.

In operation S902, the controller 370 controls the dataset engine to obtain the first data from the data platform 200. The first data may be native data output by the one or more applications. Alternatively, the first data may be converted into a standardized format prior to storage in the data platform 200.

In operation S903, the controller 370 controls to process the first data into second data for presenting in the data presentation. In an embodiment, the controller 370 may control the dataset engine 320 to convert the first data into a standardized format in operation S903. For example, the first data may be stored in its native format and may be converted by the dataset engine 320 to a standardized format prior to processing and visualization. Further, the first data may include data of different formats from different applications, and the dataset engine 320 may convert the different formats into a common or standardized format. As set forth above, however, it is understood that the first data may be converted into the standardized format prior to storage in the data platform 200. Moreover, according to an embodiment, the controller 370 may control the visualization engine 330 to process the first data into the second data for visualization, e.g., aggregating, calculating, generating visual components or graphical representations (e.g., charts, graphs, etc.) from the first data, etc.

In operation S904, the controller 370 controls the visualization engine 330 to present the second data in the data presentation (e.g., add the second data to the data presentation). For example, the controller 370 controls to add the graphical representation (e.g., chart, graph, etc.) to a particular area (e.g., tile or widget) of the data presentation.

In operation S905, the controller 370 controls to provide the data presentation to the user in accordance with the request. For example, the controller 370 may provide the data presentation to a user terminal 400 that directly accesses the data presentation system 300 via the communication interface 310. Further, the controller 370 may provide the data presentation to a user terminal 400 that accesses the data presentation system through an application (e.g., one of the applications in the application platform 100), via the API gateway (or an API in the API storage 350).

FIGS. 10A to 10G are screens of a graphical user interface for generating a data presentation according to one or more embodiments.

FIG. 10A illustrates a screen of a graphical user interface according to an embodiment that includes an element 1001 for selecting an arrangement of graphical representation areas (e.g., widgets or tiles) on the data presentation. Through this element 1001, a user may select from among a plurality of predefined arrangements (positions, shapes, and sizes) of graphical representation areas. The element 1001 may be provided as a drop-down menu in response to a menu icon being selected, though it is understood that this is only an example and other embodiments are not limited thereto.

FIG. 10B illustrates a screen including an arrangement of graphical representation areas. The screen of FIG. 10B may be displayed in response to a selection of a particular arrangement, from among a plurality of predefined arrangements, on the element 1001 of FIG. 10A. For example, in response to a user selection of a regular arrangement of square graphical representation areas via the element 1001 of FIG. 10A, the screen of FIG. 10B may be provided in which a 3×2 grid of square areas is provided. In some embodiments, upon selection of the regular arrangement of square graphical representation areas, the graphical user interface may present an element through which a user can input the number and/or resolution of square graphical representation areas to be provided. Furthermore, it is understood that in other embodiments, the screen of FIG. 10B may be provided by default and not in response to a selection of a particular arrangement of graphical representation areas.

As can be seen in the example of FIG. 10B, each of the graphical representation areas may include a selectable item (e.g., a trash can icon 1002) to remove or delete the area from the screen. Additionally, in some embodiments, the size or position of a graphical representation area may be adjusted by manipulation or inputs (e.g., touch-and-drag, etc.) to the graphical representation area (e.g., a border thereof).

Through the screen of FIG. 10B, a user may add graphical representations respectively to the plurality of graphical representation areas. To this end, the user may generate a new graphical representation or select to add an existing or previously-generated graphical representation (e.g., a widget or tile including a previously-defined graphical representation).

For example, if the user selects an option to add an existing graphical representation to a graphical representation area (e.g., by selecting “Add Existing Widget” in a particular area), then a menu or window including a listing of existing graphical representations may be displayed as shown in FIG. 10C. The listing may include various information for each pre-existing graphical representation, such as a name, one or more applications that source the data used or presented by the graphical representation, a date and/or time of creation, a name or identifier or the creator, etc. In response to selection of a pre-existing graphical representation from the listing shown in FIG. 10C (e.g., “Widget 2”), the graphical representation is added to the corresponding area in the data presentation screen, as shown in FIG. 10D.

Referring again to the screen of FIG. 10B, additional menus may be shown and hidden from view via manipulation (e.g., selection, touch-and-drag, etc.) of menu display toggle items 1003, 1004. For example, in response to manipulation of the menu display item 1004, a window or menu 1005 for adding a new graphical representation is displayed, as shown in FIG. 10D. Through the menu 1005, a user may select from among a plurality of predetermined graphical representation types (e.g., table, card, bar graph, line chart, etc.) to add to a particular graphical representation area. In the example shown in FIG. 10D, the user may select to add a new column chart from among the plurality of predetermined graphical representation types. To this end, the user may drag-and-drop the graphical representation type from the menu to the corresponding graphical representation area to which the graphical representation is added, though this is merely an example and any type of selection input may be implemented in various embodiments.

Additionally, in response to manipulation of the menu display item 1003, a window or menu 1006 for adding datasets to and defining properties (e.g., title, axes, styles, filters, etc.) of a selected graphical representation (such as the newly-added graphical representation) is displayed, as shown in FIG. 10E. Through the menu 1006, a list 1007 of predetermined datasets or data (first data) stored in the data platform 200 may be presented for selection. For example, the list 1007 may be of datasets related to or sourced by a same application as those of another graphical representation (e.g., “Products Chart”) already presented on the screen. Alternatively or additionally, the list 1007 may include most recently used datasets, most frequently used datasets, etc. The list 1007 may also present, under a particular dataset (e.g., “Dataset 1”), items (e.g., columns or rows) of data included within that dataset. The list 1007 may further include a graphical icon for each item that represents the type of data of that item (date format, time format, number format, character format, etc.). Additionally, a user may search for a particular dataset via manual entry to a search input field 1008, or may select an icon 1009 for displaying a list of all available datasets (which can be filtered or sorted by application source, data type, creation date, etc.) through which one or more datasets may be added to the list 1007 or to a particular axis of a graphical representation. A dataset may be selected by a user to be presented on the graphical representation, e.g., by dragging-and-dropping a dataset from the list 1007 to a particular axis as provided in the properties menu 1006. Upon adding the datasets to the axes, the visualization engine 330 (FIG. 2) processes the datasets into second data (e.g., a column chart or bar graph) for display in the graphical representation area 1010, as shown in FIG. 10F.

Referring to FIGS. 10E and 10F, the properties menu 1006 may also include a Style tab (or sub-menu) for defining styles used in the corresponding (e.g., currently selected) graphical representation area, such as the colors of each dataset (bar, column, etc.) being presented, font sizes, styles, and colors used in the graphical representation, display units for numerical datasets, display positions of labels, etc. Additionally, the properties menu 1006 may include a tab or selectable sub-menu for defining a column or field of the graphical representation based on a user-defined formula or calculation with respect to one or more datasets. Such a calculated field may then be added to an axis of the graphical representation.

FIG. 10G illustrates a screen in which the generated data presentation is completed. Upon completion, the data presentation may be published (e.g., transmitted, emailed, or saved on a website or shared drive, etc.) and/or saved in the data presentation storage 340, so that an authorized user can access the data presentation from the centralized data presentation system.

FIG. 11 is a diagram of components of one or more devices according to an embodiment. Device 1100 may correspond to a computing device described above (e.g., at least one server or device that implements or embodies the data presentation system 300, at least one server or device that stores or deploys the application platform 100, at least one server or device that implements or embodies the data platform 200, at least one user terminal 400, etc.).

As shown in FIG. 11, the device 1000 may include a bus 1110, a processor 1120, a memory 1130, a storage component 1140, an input component 1150, an output component 1160, and a communication interface 1170. It is understood that one or more of the components may be omitted and/or one or more additional components may be included.

The bus 1110 includes a component that permits communication among the components of the device 1100. The processor 1120 is implemented in hardware, firmware, or a combination of hardware and software. The processor 1120 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The process 1120 includes one or more processors capable of being programmed to perform a function.

The memory 1130 includes a random access memory (RAM), a read only memory (ROM), and/or another type of dynamic or static storage device (e.g., a flash memory, a magnetic memory, and/or an optical memory) that stores information and/or instructions for use by the processor 1120.

The storage component 1140 stores information and/or software related to the operation and use of the device 1100. For example, the storage component 1140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 1150 includes a component that permits the device 1100 to receive information, such as via user input (e.g., a touch screen display, a keyboard, a keypad, a mouse, a button, a switch, and/or a microphone). The input component 1150 may include a sensor for sensing information (e.g., a global positioning system (GPS) component, an accelerometer, a gyroscope, and/or an actuator).

The output component 1160 includes a component that provides output information from the device 1100 (e.g., a display, a speaker, and/or one or more light-emitting diodes (LEDs)).

The communication interface 1170 includes a transceiver-like component (e.g., a transceiver and/or a separate receiver and transmitter) that enables the device 1100 to communicate with other devices, such as via a wired connection, a wireless connection, or a combination of wired and wireless connections. The communication interface 1170 may permit device 1100 to receive information from another device and/or provide information to another device. For example, the communication interface 1170 may include an Ethernet interface, an optical interface, a coaxial interface, an infrared interface, a radio frequency (RF) interface, a universal serial bus (USB) interface, a Wi-Fi interface, a cellular network interface, or the like.

The device 1100 may perform one or more processes described herein. The device 1100 may perform operations based on the processor 1120 executing software instructions stored by a non-transitory computer-readable medium, such as the memory 1130 and/or the storage component 1140. A computer-readable medium is defined herein as a non-transitory memory device. A memory device includes memory space within a single physical storage device or memory space spread across multiple physical storage devices.

Software instructions may be read into the memory 1130 and/or the storage component 1140 from another computer-readable medium or from another device via the communication interface 1170. When executed, software instructions stored in the memory 1130 and/or storage component 1140 may cause the processor 1120 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of providing access to a data presentation system communicably connected to an application platform deploying a plurality of applications, and a data platform storing data output from the plurality of applications, the method comprising:
receiving, by the data presentation system, a request from a user to access a data presentation based on data output by at least one of the plurality of applications;
determining, by the data presentation system, whether the received request is permitted; and
based on the received request being permitted, processing the received request,
wherein the processing the received request comprises:
determining first data of one or more applications, from among the data stored in the data platform, for presenting in the data presentation according to the request,
obtaining, by the data presentation system, the first data from the data platform,
processing, by the data presentation system, the first data into second data for presenting in the data presentation,
adding the second data to the data presentation, and
providing the data presentation to the user in accordance with the request.

2. The method according to claim 1, wherein the determining whether the received request is permitted comprises authenticating the user and determining whether the user has a preset permission for the requested access according to at least one of:
preset user access rights defining access rights for the data presentation system on a per-user basis;
preset group access rights defining access rights for the data presentation system on a per-group of user basis;
preset data presentation access rights defining access rights for the data presentation system on a per-data presentation basis; and
preset application access rights defining access rights for the data presentation on a per-application basis.

3. The method according to claim 2, wherein the determining whether the user has the preset permission comprises determining a preset role of the user from among a plurality of predetermined roles each corresponding to different access rights.

4. The method according to claim 1, wherein the data presentation system is configured to permit any of generating, editing, and viewing of data presentations when the request is a direct request from a user terminal that directly accesses the data presentation system via a graphical user interface of the data presentation system, and to not permit generating and editing of data presentations when the request is an indirect request via an application from among the plurality of applications.

5. The method according to claim 1, wherein the processing the first data into the second data comprises standardizing a format of the first data into a standard format for the data presentation system.

6. The method according to claim 5, wherein the first data comprises data output by a first application and having a first format, among the plurality of applications, and data output by a second application, among the plurality of applications, and having a second format different from the first format.

7. The method according to claim 1, wherein the processing the first data into the second data comprises at least one of aggregating the first data, performing calculations on the first data, and generating visualization items based on the first data.

8. The method according to claim 1, further comprising:
based on the received request being permitted and being a request to generate or to edit the data presentation, configuring the data presentation according to user inputs,
wherein the configuring the data presentation comprises receiving, from a user terminal, the user inputs to a graphical user interface of the data presentation system, the user inputs comprising at least one of:
a first user input to select the first data from among the data stored in the data platform,
a second user input to select one or more applications, from among the plurality of applications, as sources of the first data, and
a third user input to select measures and/or dimensions corresponding to the second data for visualization in the data presentation.

9. The method according to claim 1, further comprising:
based on the received request being permitted and being a request to view the data presentation, obtaining the data presentation from a data presentation storage of the data presentation system.

10. A centralized data presentation system for providing access to data presentations, the centralized data presentation system comprising:
a communication interface;
an application programming interface (API) gateway;
a memory storing instructions; and
at least one processor configured to execute the instructions to:
receive, via the communication interface or an API managed by the API gateway, a request from a user to access a data presentation based on data output by at least one of a plurality of applications deployed by an application platform communicably connected to the centralized data presentation system via the API gateway,
determine whether the received request is permitted,
based on the received request being permitted, processing the received request by:
determining first data of one or more applications, from among data output by the plurality of applications and stored in a data platform communicably connected to the centralized data presentation system, for presenting in the data presentation according to the request,
obtaining, by the data presentation system, the first data from the data platform,
processing, by the data presentation system, the first data into second data for presenting in the data presentation,
adding the second data to the data presentation, and
providing the data presentation to the user in accordance with the request.

11. The centralized data presentation system according to claim 10, wherein the at least one processor is further configured to execute the instructions to determine whether the received request is permitted by authenticating the user and determining whether the user has a preset permission for the requested access according to at least one of:
preset user access rights defining access rights for the data presentation system on a per-user basis;
preset group access rights defining access rights for the data presentation system on a per-group of user basis;
preset data presentation access rights defining access rights for the data presentation system on a per-data presentation basis; and
preset application access rights defining access rights for the data presentation on a per-application basis.

12. The centralized data presentation system according to claim 11, wherein the at least one processor is further configured to execute the instructions to determine whether the user has the preset permission by determining a preset role of the user from among a plurality of predetermined roles each corresponding to different access rights.

13. The centralized data presentation system according to claim 10, wherein the centralized data presentation system is configured to permit any of generating, editing, and viewing of data presentations when the request is a direct request from a user terminal that directly accesses the data presentation system via a graphical user interface of the data presentation system, and to not permit generating and editing of data presentations when the request is an indirect request via an application from among the plurality of applications.

14. The centralized data presentation system according to claim 10, wherein the at least one processor is further configured to execute the instructions to process the first data into the second data by standardizing a format of the first data into a standard format for the centralized data presentation system.

15. The centralized data presentation system according to claim 14, wherein the first data comprises data output by a first application and having a first format, among the plurality of applications, and data output by a second application, among the plurality of applications, and having a second format different from the first format.

16. The centralized data presentation system according to claim 10, wherein the at least one processor is further configured to execute the instructions to process the first data into the second data by at least one of aggregating the first data, performing calculations on the first data, and generating visualization items based on the first data.

17. The centralized data presentation system according to claim 10, wherein:
the at least one processor is further configured to execute the instructions to, based on the received request being permitted and being a request to generate or to edit the data presentation, configure the data presentation according to user inputs, by receiving, from a user terminal, the user inputs to a graphical user interface of the data presentation system, the user inputs comprising at least one of:
a first user input to select the first data from among the data stored in the data platform,
a second user input to select one or more applications, from among the plurality of applications, as sources of the first data, and
a third user input to select measures and/or dimensions corresponding to the second data for visualization in the data presentation.

18. The centralized data presentation system according to claim 10, further comprising:
a data presentation storage configured to store data presentations,
wherein the at least one processor is further configured to, based on the received request being permitted and being a request to view the data presentation, obtain the data presentation from the data presentation storage.

19. A non-transitory computer-readable recording medium having recorded thereon instructions executable by at least one processor to perform a method of providing access to a data presentation system communicably connected to an application platform deploying a plurality of applications, and a data platform storing data output from the plurality of applications, the method comprising:
receiving, by the data presentation system, a request from a user to access a data presentation based on data output by at least one of the plurality of applications;
determining, by the data presentation system, whether the received request is permitted; and
based on the received request being permitted, processing the received request,
wherein the processing the received request comprises:
determining first data of one or more applications, from among the data stored in the data platform, for presenting in the data presentation according to the request,
obtaining, by the data presentation system, the first data from the data platform,
processing, by the data presentation system, the first data into second data for presenting in the data presentation,
adding the second data to the data presentation, and
providing the data presentation to the user in accordance with the request.
